(19) United States
(12) Patent Application Publication
(10) Pub. No.: US 2013/0300104 A1
(43) Pub. Date: Nov. 14, 2013

(54) ADJUSTABLE ELBOWS AND METHOD FOR USING THE SAME

(71) Applicant: Greg Harmon, Cedar Bluff, VA (US)

(72) Inventor: Greg Harmon, Cedar Bluff, VA (US)

(21) Appl. No.: 13/871,725

(22) Filed: Apr. 26, 2013

Related U.S. Application Data
(60) Provisional application No. 61/640,228, filed on Apr. 30, 2012.

(51) Int. Cl. F16L 27/12; F16L 23/18

(52) U.S. Cl. CPC F16L 27/12; F16L 23/18
USPC 285/93; 285/181

(57) ABSTRACT

An approach is provided for an adjustable elbow and method for using the same. The adjustable elbow includes a first section, and a second section telescopically fitted into the first section to adjust an angle of the elbow.

### RELATED APPLICATIONS

This application claims priority to U.S. Provisional Application Ser. No. 61/640,228, filed Apr. 30, 2012; the entirety of which is incorporated herein by reference.

### BACKGROUND

Some industrial elbows are casted metal or alloy in fixed sizes, e.g., in a variety of center line radius and wall thicknesses. By way of example, these elbows have a center line radius that is an industry standard such as 1× the diameter, 1.5× the diameter, and 2× the diameter etc. They are conventionally available in 90 and 45 fixed degree angles only. When a 65 degree elbow is needed, one must purchase a 90 degree elbow, and saw, cut or torch cut the 90 degree elbow to the desired degree. This process is time consuming and requires an experienced mechanic in the pipe fitting trade.

Alternatively, these elbows can be made from segments of a round pipe and/or flat mild steel plates/sheets. These types of elbows are also manufactured according to the standardized center line radius. The segments of a round pipe can be stacked and welded together to achieve the desired degree. These elbows are usually lined with a wear resistant material such as alumina oxide ceramic tile, tungsten carbide, monolithic moldings, abrasion resistant metal, silica carbide, etc. Usually, an engineering firm or fabrication shop sends an individual on site to measure the degree of the elbow so the made one to fit in the field. However, the degrees of the elbows are fixed and un-adjustable.

### SOME EXAMPLE EMBODIMENTS

Therefore, there is a need for an approach for providing adjustable elbows.

According to one embodiment, the adjustable elbow includes a first section, and a second section telescopically fitted into the first section to adjust an angle of the elbow.

According to one embodiment, a method is provided for installing the adjustable elbow.

According to one embodiment, a method is provided for manufacturing the adjustable elbow.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIGS. 1A-1B are perspective views of an adjustable elbow set for a direction change of about 45 degrees, according to one embodiment;

FIG. 1C includes cross-sectional views of the adjustable elbow, according to one embodiment;

FIGS. 1D-1E are front views of two flange plates of the adjustable elbow, according to one embodiment;

FIGS. 1F-1G are front cross-sectional of the two flange plates of the adjustable elbow, according to one embodiment;

FIGS. 2A-2B are perspective views of an adjustable elbow set for a direction change of about 67.5 degrees, according to one embodiment;

FIG. 2C includes cross-sectional views of the adjustable elbow, according to one embodiment;

FIGS. 3A-3B are perspective views of an adjustable elbow set for a direction change of about 90 degrees, according to one embodiment;

FIG. 3C includes cross-sectional views of the adjustable elbow, according to one embodiment;

FIGS. 4A-4B are perspective views of an adjustable elbow set for a direction change of about 45 degrees, according to one embodiment;

FIG. 4C includes cross-sectional views of the adjustable elbow, according to one embodiment;

FIG. 4D includes cross-sectional views of flange plates of the adjustable elbow, according to one embodiment;

FIGS. 5A-5B are perspective views of an adjustable elbow set for a direction change of about 67.5 degrees, according to one embodiment;

FIG. 5C includes cross-sectional views of the adjustable elbow, according to one embodiment;

FIGS. 6A-6B are perspective views of an adjustable elbow set for a direction change of about 90 degrees, according to one embodiment;

FIG. 6C includes cross-sectional views of the adjustable elbow, according to one embodiment;

FIGS. 7A-7B are perspective views of an adjustable elbow set for a direction change of about 45 degrees, according to one embodiment;

FIG. 7C includes cross-sectional views of the adjustable elbow, according to one embodiment;

FIG. 7D includes cross-sectional views of flange plates of the adjustable elbow, according to one embodiment;

FIG. 7E includes additional cross-sectional views of flange plates of the adjustable elbow, according to one embodiment;

FIGS. 8A-8B are perspective views of an adjustable elbow set for a direction change of about 67.5 degrees, according to one embodiment;

FIG. 8C includes cross-sectional views of the adjustable elbow, according to one embodiment;

FIGS. 9A-9B are perspective views of an adjustable elbow set for a direction change of about 90 degrees, according to one embodiment;

FIG. 9C includes cross-sectional views of the adjustable elbow, according to one embodiment;

FIGS. 10A-10B are perspective views of an adjustable elbow set for a direction change of about 45 degrees, according to one embodiment;

FIG. 10C includes cross-sectional views of the adjustable elbow, according to one embodiment;

FIGS. 11A-11B are perspective views of an adjustable elbow set for a direction change of about 67.5 degrees, according to one embodiment;

FIG. 11C includes cross-sectional views of the adjustable elbow, according to one embodiment;

FIGS. 12A-12B are perspective views of an adjustable elbow set for a direction change of about 90 degrees, according to one embodiment; and

FIG. 12C includes cross-sectional views of the adjustable elbow, according to one embodiment.

### DESCRIPTION OF SOME EMBODIMENTS

Examples of adjustable elbows and methods for using the same are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term elbow refers to a pipe fitting installed between two lengths of pipe or tubing to allow a change of direction. Elbows may be used to adapt to different sizes or shapes, and for other purposes, such as regulating or measuring fluid flow. Although various embodiments are described with respect to a change of direction of 45-90 degrees, it is contemplated that the approach described herein may be used with a change of direction of other degree (e.g., 22.5°).

The elbow 100 is adjustable in a range of degrees, e.g., 22.5-90 degrees. In some embodiments, the elbow 100 is manufactured are made in a variety of industrial standard sizes, such as center line radius and wall thicknesses. In some embodiments, the elbow 100 is manufactured are made in a variety of custom sizes to fit special needs, such as for a laboratory facility.

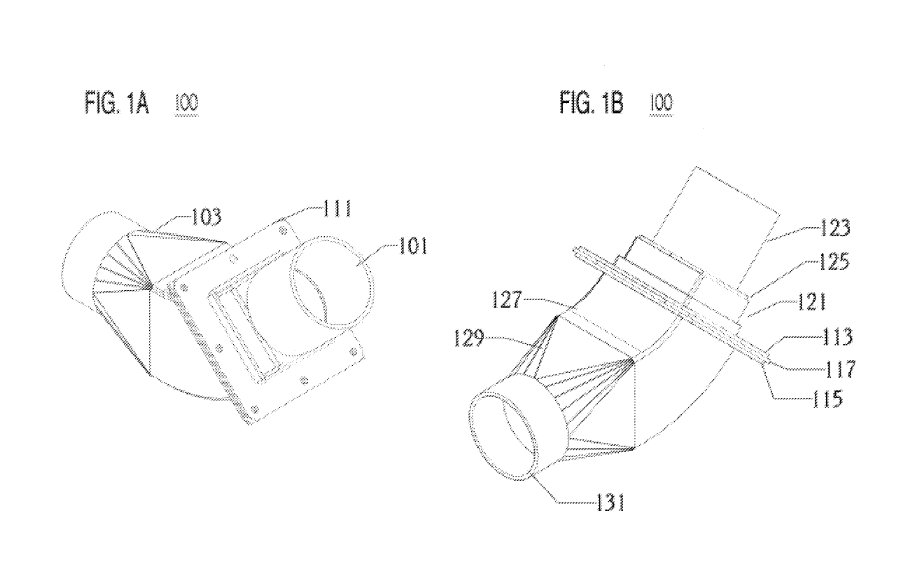

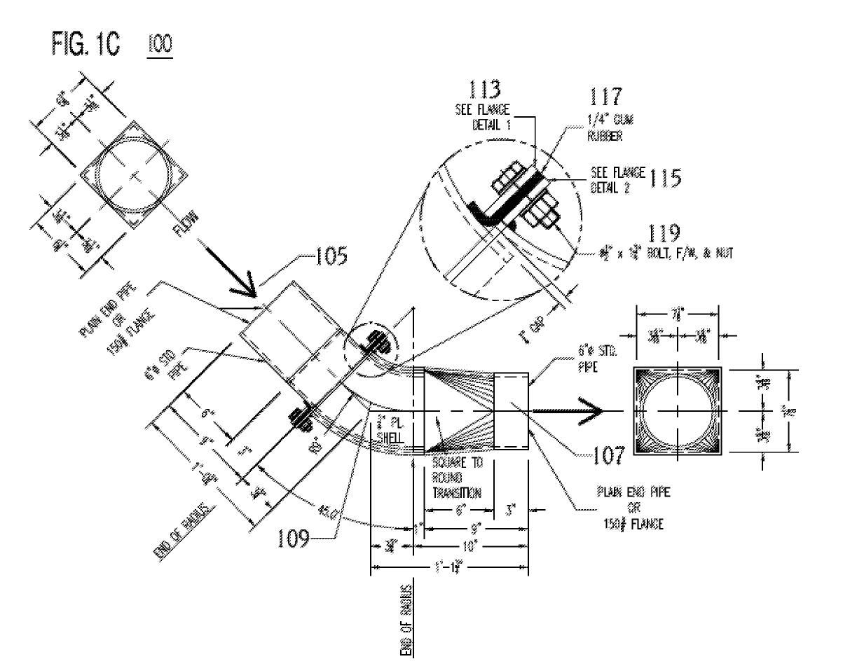

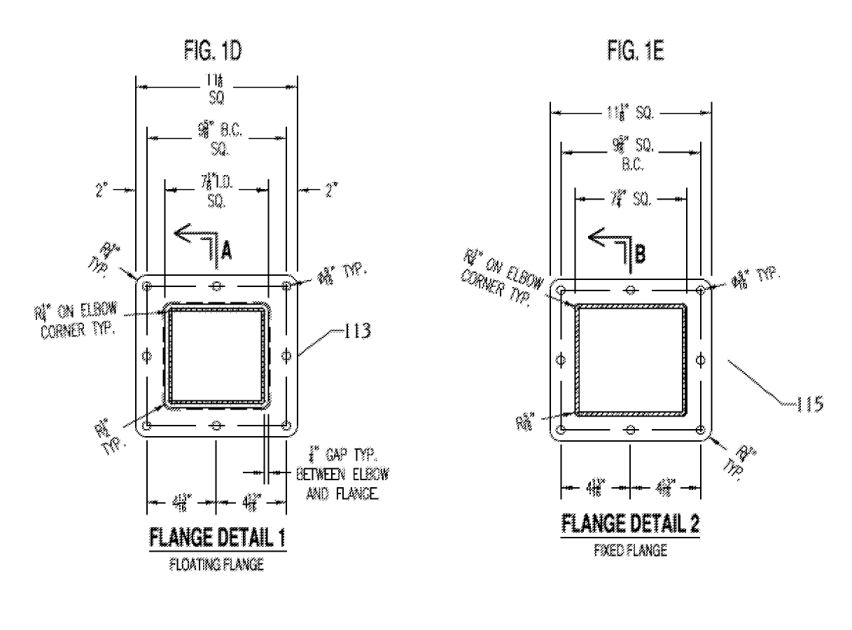

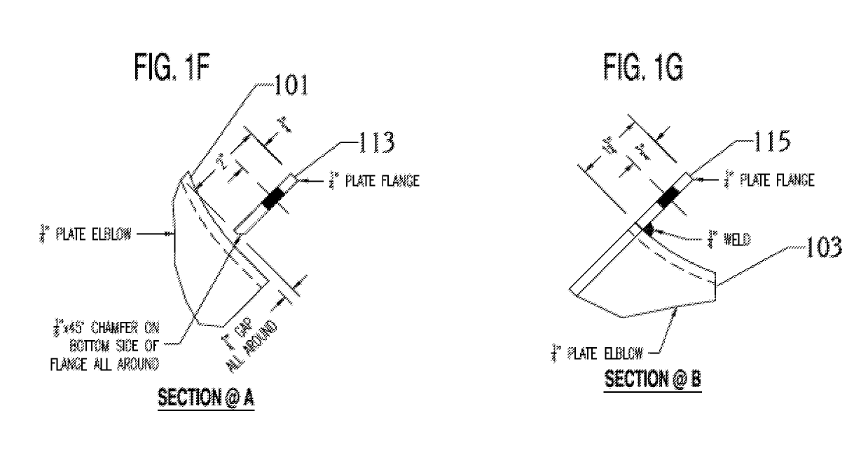

FIGS. 1A-1B are perspective views of an adjustable elbow set for a direction change of about 45 degrees, according to one embodiment. The elbow 100 can be made of mild steel flat plates and round pipes as described in more detail later. The elbow 100 includes an upper section 101 and a lower section 103. FIG. 1C is cross-sectional view of the adjustable elbow, according to one embodiment. The lower section 103 is made with larger inside dimensions than the upper section 101 so that the upper section 101 can fit into the lower section 103 with sufficient tolerances for fitting. The upper section 101 is fitted into the lower section 103 in a telescopic motion along their centre lines 105 and 107, while using a cross point 109 of their centre lines as a pivot point. FIGS. 1D-1E are front views of two flange plates of the adjustable elbow, according to one embodiment. At the mid-point along the centre line radius is a flange 111 that is made of two pieces of mild steel flat plates 113, 115 with one or more gaskets 117 (e.g., gum rubber) in-between. FIGS. 1F-1G are front cross-sectional of the two flange plates of the adjustable elbow, according to one embodiment. By tightening the bolts 119 and engaging the flat plates 113, 115, the flat plates 113, 115 press the gaskets 117 between them as well as against the body of the upper section 101 to seal off any potential leaks. In one embodiment, the elbow 100 is lined with the various liners to match inside diameters of existing pipes. The elbow 100 can be made of plastic, copper, cast iron, steel, lead, etc. The liners can be made of a wear resistant material such as alumina oxide ceramic tile, tungsten carbide, monolithic moldings, abrasion resistant metal, silica carbide, etc.

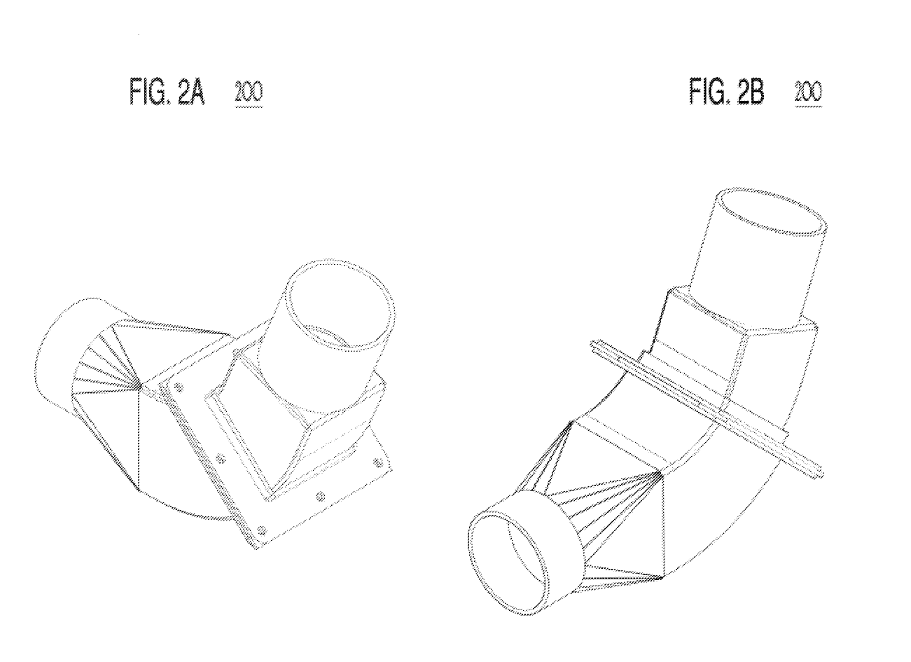

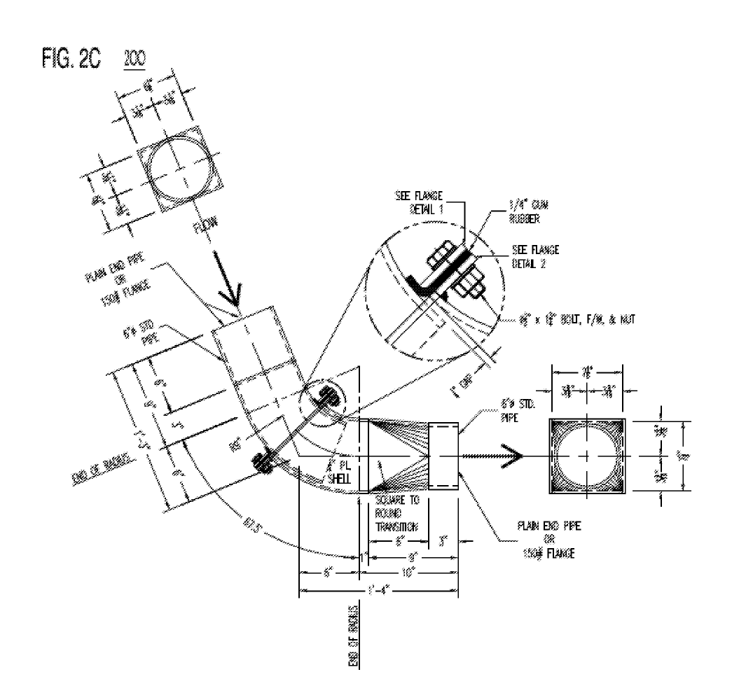

In one embodiment, the elbow 100 is installed as follows. Initially, the two sections of the elbow 100 are engaged with each other in 45 degree as shown in FIG. 1A. After taking an existing, warn-out elbow out of a pipe line, the lower section 105 of the elbow 100 is bolted or coupled to one end of the existing pipe line, then the upper section 101 is pull out of the lower section 103 until the upper section 101 is bolted or coupled to the other end of the existing pipe line. By way of example, FIGS. 2A-2B are perspective views of an adjustable elbow 200 set for a direction change of about 67.5 degrees, according to one embodiment, and FIG. 2C is cross-sectional view of the adjustable elbow, according to one embodiment.

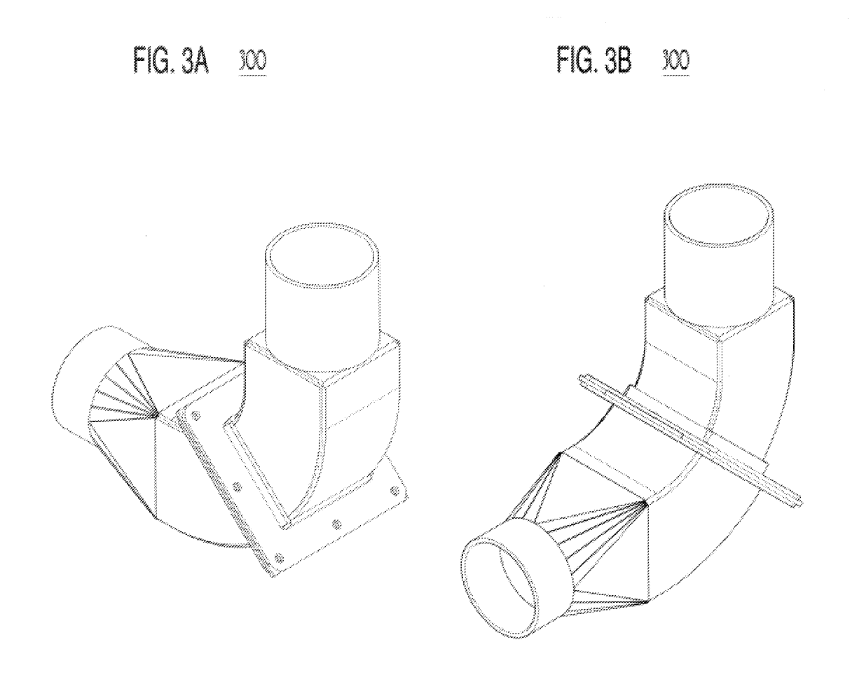

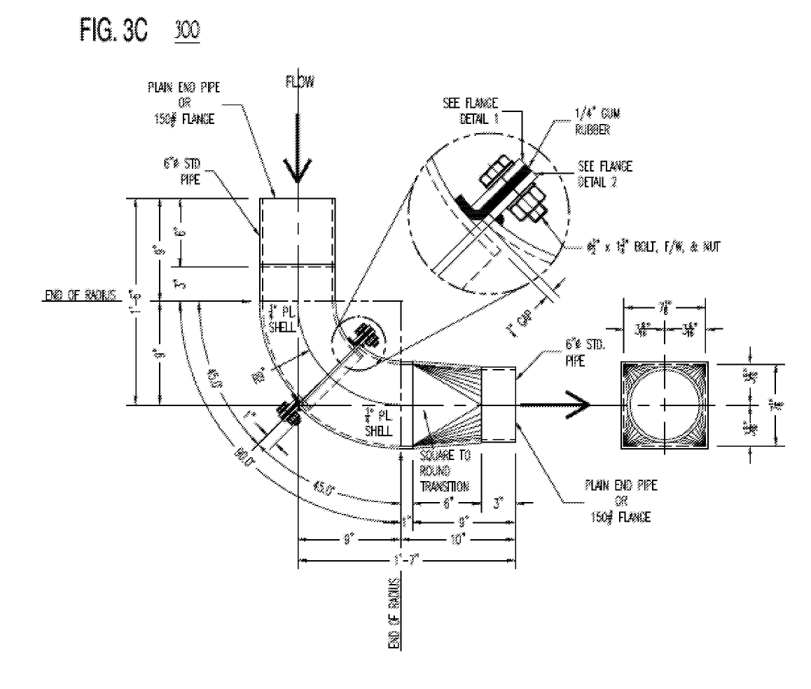

As another example, FIGS. 3A-3B are perspective views of an adjustable elbow 300 set for a direction change of about 90 degrees, according to one embodiment, and FIG. 3C is cross-sectional view of the adjustable elbow, according to one embodiment.

Thereafter, the bolts 119 in the flange 111 are tightened to compress the gaskets 117 and seal around the elbow. In this manner, a desired degree is reached and the pipe line is back in use quickly.

In some embodiments, the elbows (e.g., 100) are manufactured out of mild steel plates, while the other elbows (e.g., 900) are manufactured out of, e.g., polyvinyl chloride (PVC). By way of example, the upper section 101 includes a square box section 121 and a pipe section 123. A mild steel plate is made into the square box section 121 with inside dimensions matching the inside diameter of the pipe section 123 (e.g., of 4″-36″ diameter). The pipe section 123 can be mated to the square box section 121 with a flat plate 125 welded to both the pipe section 123 and the square box section 121. The lower section 103 includes a square box section 127, a square-to-round transition/reducer 129 and a pipe section 131. The square box section 127 is mated to the pipe section 131 by the square-to-round transition 129 fabricated out of a mild steel flat plate. The square-to-round transition 129 also serves to transition the flow of material through the box portion of the elbow 100 back into the round pipeline with a smoother and less turbulent flow to minimum wear and tear to the elbow 100 and the pipeline. Using a flat plate (rather than such a transition piece) to mate the box portion of the elbow back to the pipe portion will restrict flow and cases a high wear and tear at the joint.

The pipe section 123 and the pipe section 131 are short pieces of a round pipe sized to a customer's needs. They can be manufactured to have a standard or non standard plain end or flange connection for coupling.

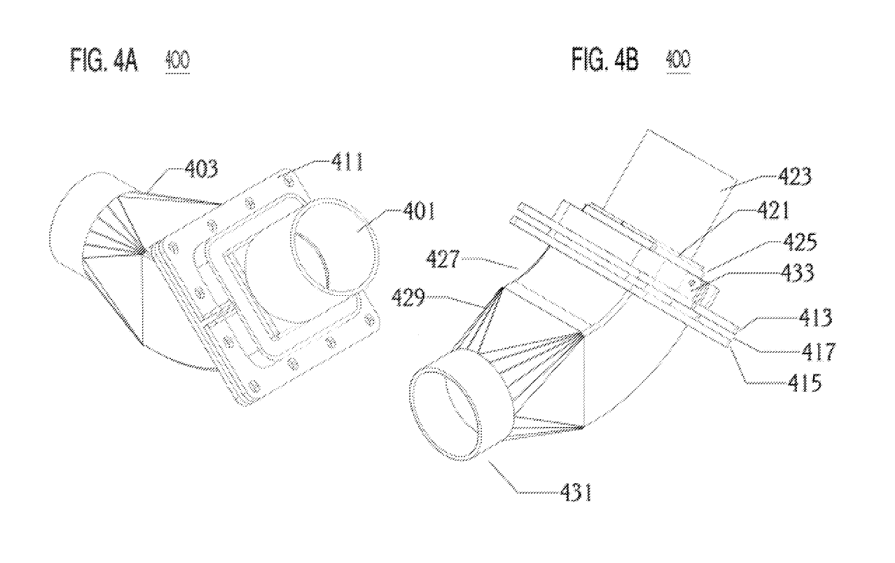

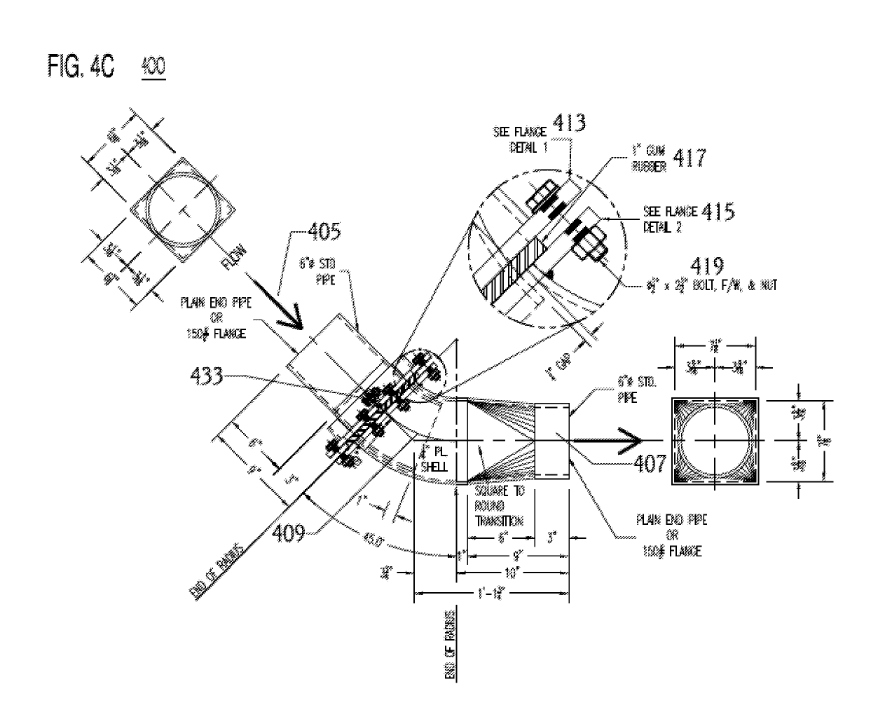

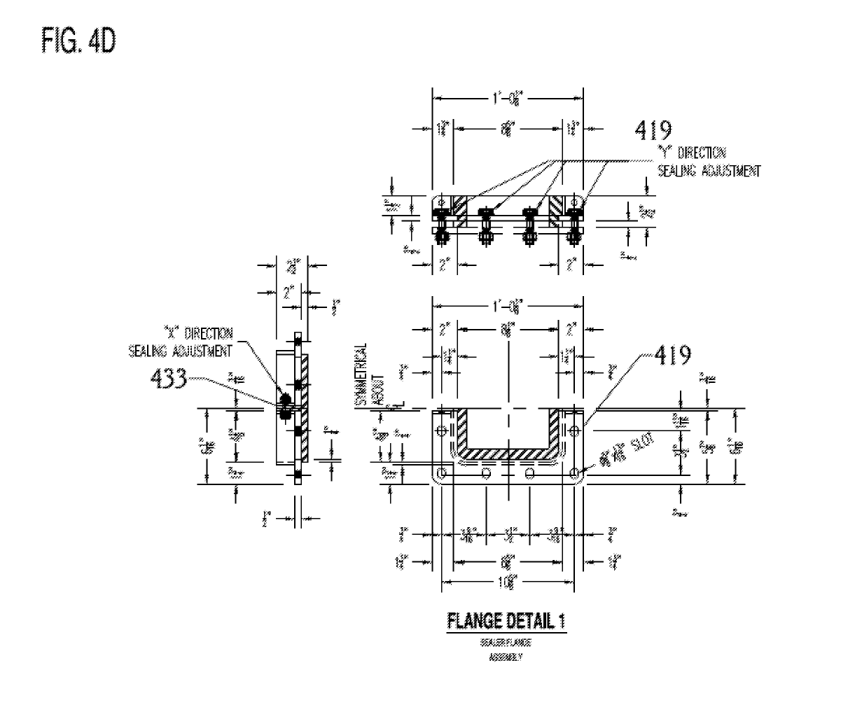

FIGS. 4A-4B are perspective views of an adjustable elbow set for a direction change of about 45 degrees, according to one embodiment. The elbow 400 is made of mild steel flat plates. The elbow 400 includes an upper section 401 and a lower section 403. FIG. 4C is cross-sectional view of the adjustable elbow, according to one embodiment. The lower section 403 is made with larger inside dimensions than the upper section 401 so that the upper section 401 can fit into the lower section 403 with sufficient tolerances for fitting. The upper section 401 is fitted into the lower section 403 in a telescopic motion along their centre lines 405 and 407, while using a cross point 409 of their centre lines as a pivot point.

FIG. 4C includes cross-sectional views of the adjustable elbow, according to one embodiment. At the mid-point along the centre line radius is a flange 411 that is made of two pieces of mild steel flat plates 413, 415 with one or more gaskets 417 (e.g., gum rubber) in-between. Referring back to FIG. 1D, cross directional flange plates 413, 415 are smaller than the flange plates 113, 115. Tightening the bolts 419 on the smaller cross directional flange plates 413, 415 presses the gaskets 417 in-between the plates 413, 415 as well as against the body of the upper section 401.

FIG. 4D includes cross-sectional views of flange plates of the adjustable elbow, according to one embodiment. In addition to bolts 419, there is a side adjustment bolt 433, that is absent from FIG. 1D. Tightening the bolt 433 further compresses the gasket 417 against the body of the upper section 401 of the elbow to ensure sealing. The bolts 419 and the bolt 433 in the cross directional flange points provide the embodiment a bi-directional sealing capability.

In one embodiment, the elbow 400 is lined with the various liners to match inside diameters of existing pipes. The elbow 400 can be made of plastic, copper, cast iron, steel, lead, etc. The liners can be made of a wear resistant material such as alumina oxide ceramic tile, tungsten carbide, monolithic moldings, abrasion resistant metal, silica carbide, etc.

By way of example, the upper section 401 includes a square box section 421 and a pipe section 423. A mild steel plate is made into the square box section 421 with inside dimensions matching the inside diameter of the pipe section 423 (e.g., of 4″-36″ diameter). The pipe section 423 can be mated to the square box section 421 with a flat plate 425 welded to both the pipe section 423 and the square box section 421. The lower section 403 includes a square box section 427, a square-to-round transition/reducer 429 and a pipe section 431. The square box section 427 is mated to the pipe section 431 by the square-to-round transition 429 fabricated out of a mild steel flat plate. The square-to-round transition 429 also serves to transition the flow of material through the box portion of the elbow 400 back into the round pipeline with a smoother and less turbulent flow to minimum wear and tear to the elbow 400 and the pipeline. Using a flat plate (rather than such a transition piece) to mate the box portion of the elbow back to the pipe portion will restrict flow and cases a high wear and tear at the joint.

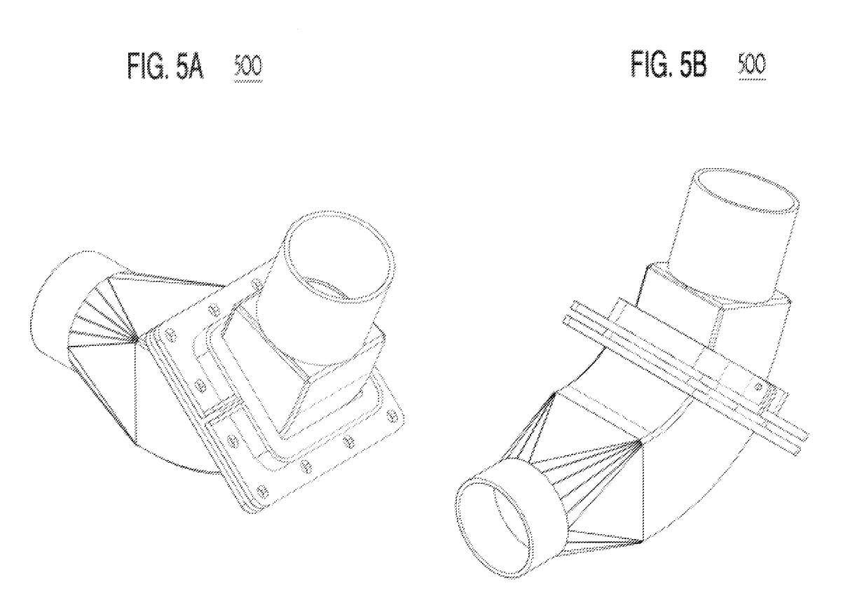

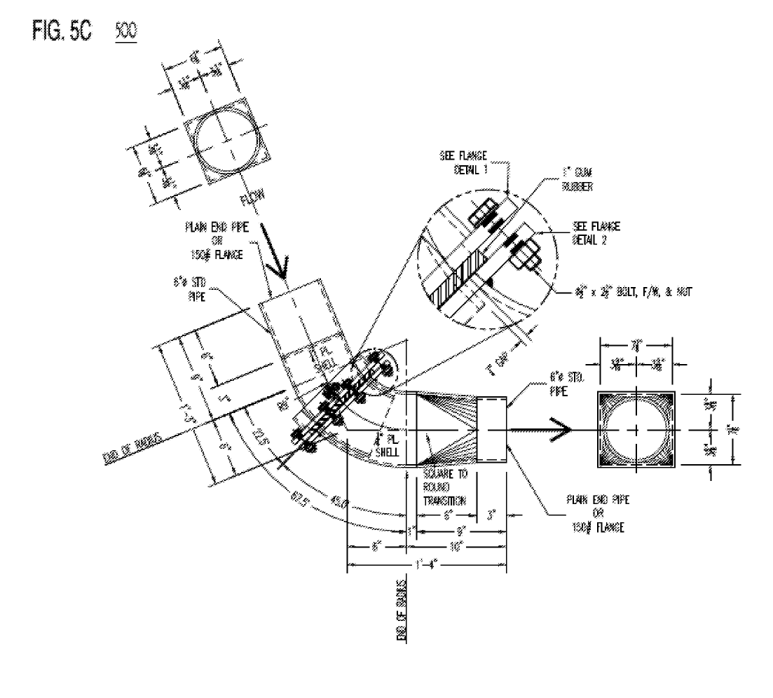

In one embodiment, the elbow 400 is installed as follows. Initially, the two sections of the elbow 100 are engaged with each other at about 45 degrees as shown in FIG. 4A. After taking an existing, warn-out elbow out of a pipe line, the lower section 405 of the elbow 400 is bolted or coupled to one end of the existing pipe line, then the upper section 101 is pull out of the lower section 403 until the upper section 401 is bolted or coupled to the other end of the existing pipe line. By way of example, FIGS. 5A-5B are perspective views of an adjustable elbow 500 set for a direction change of about 67.5 degrees, according to one embodiment, and FIG. 5C includes cross-sectional views of the adjustable elbow, according to one embodiment.

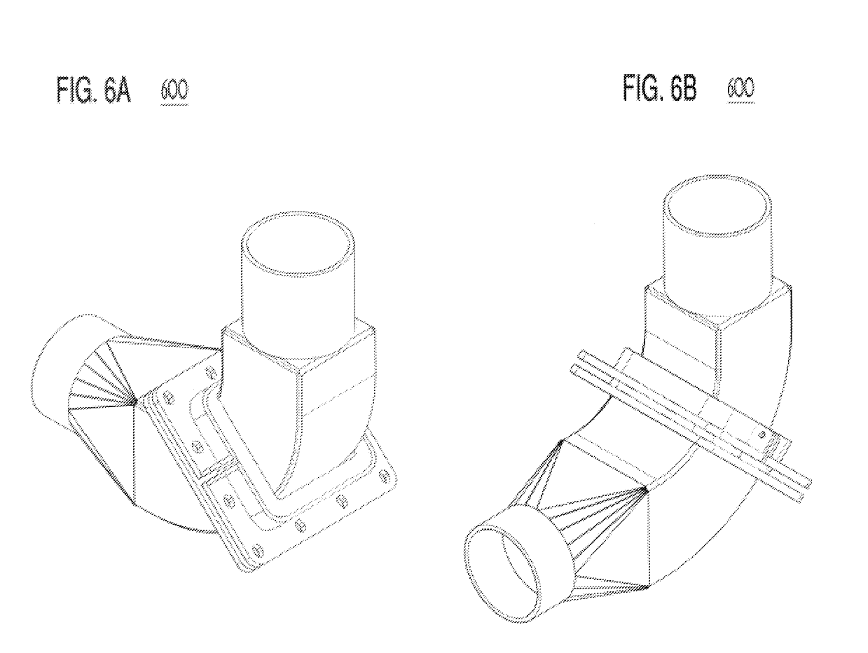

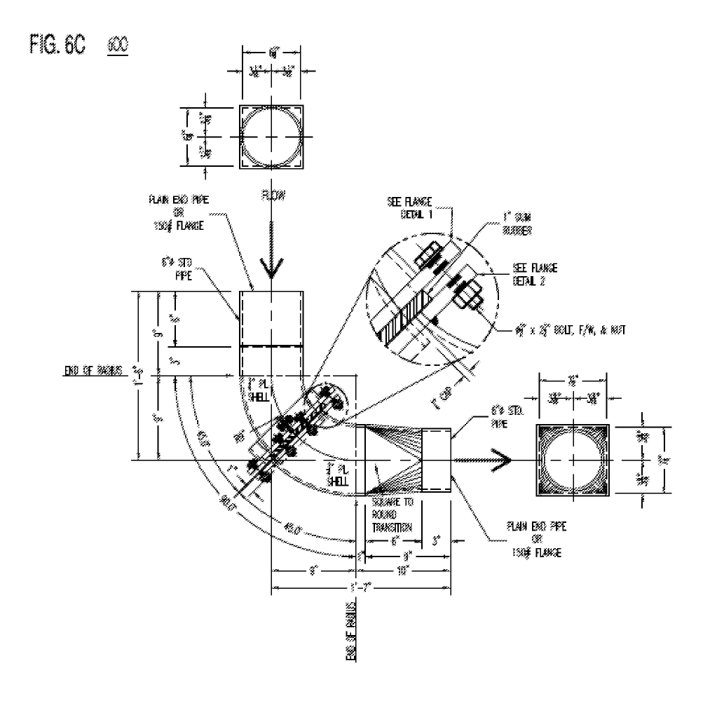

As another example, FIGS. 6A-6B are perspective views of an adjustable elbow 600 set for a direction change of about 90 degrees, according to one embodiment; and FIG. 6C includes cross-sectional views of the adjustable elbow, according to one embodiment.

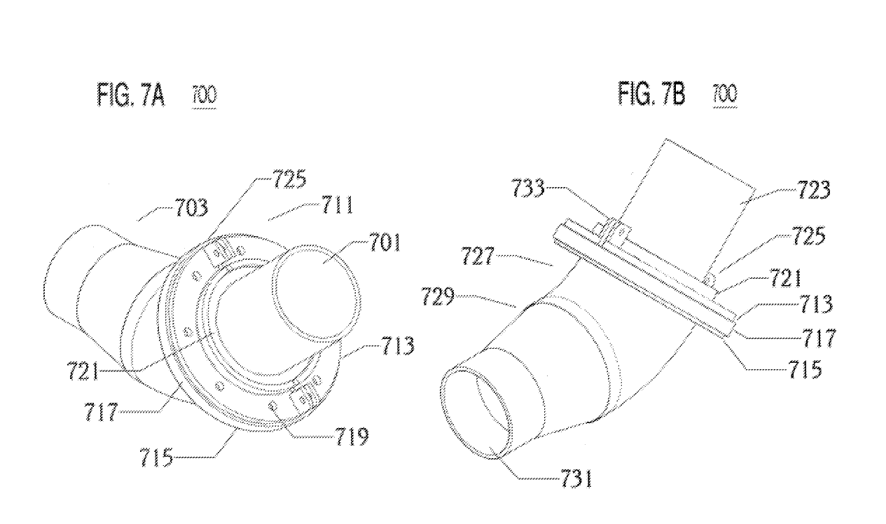

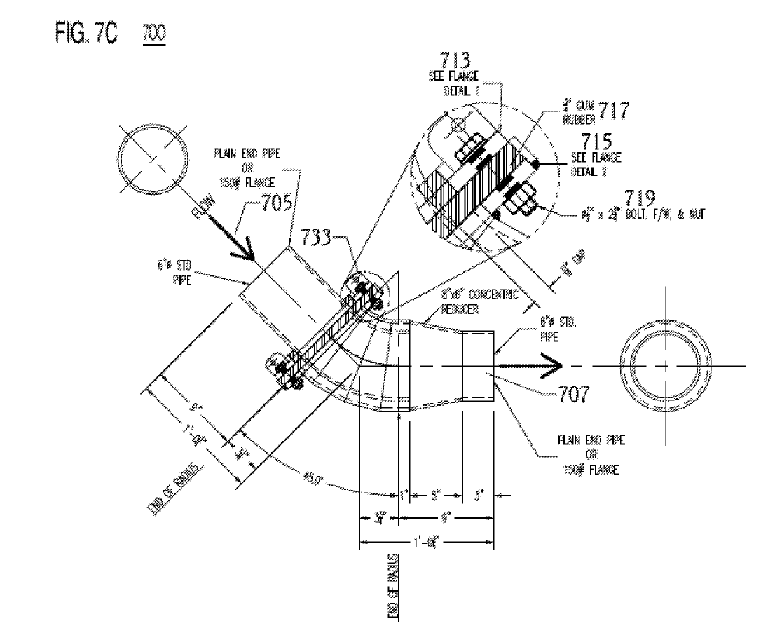

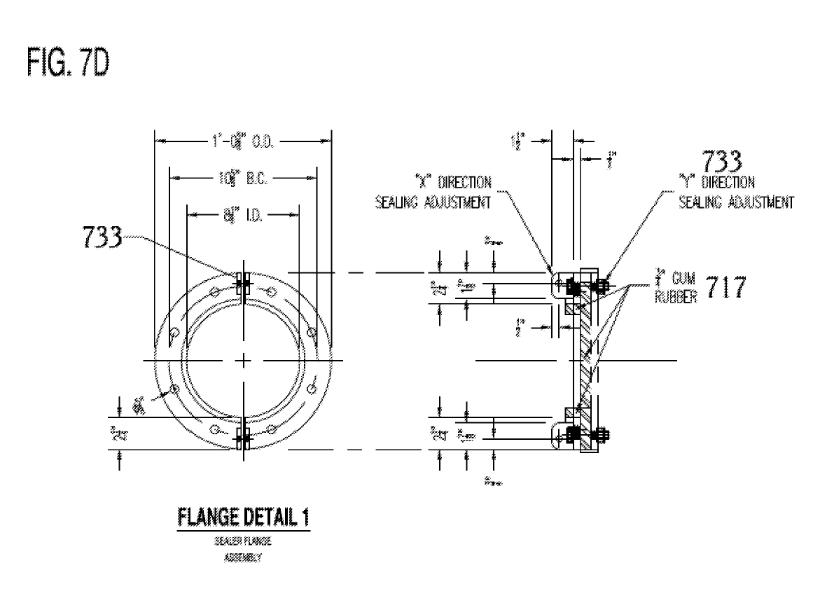

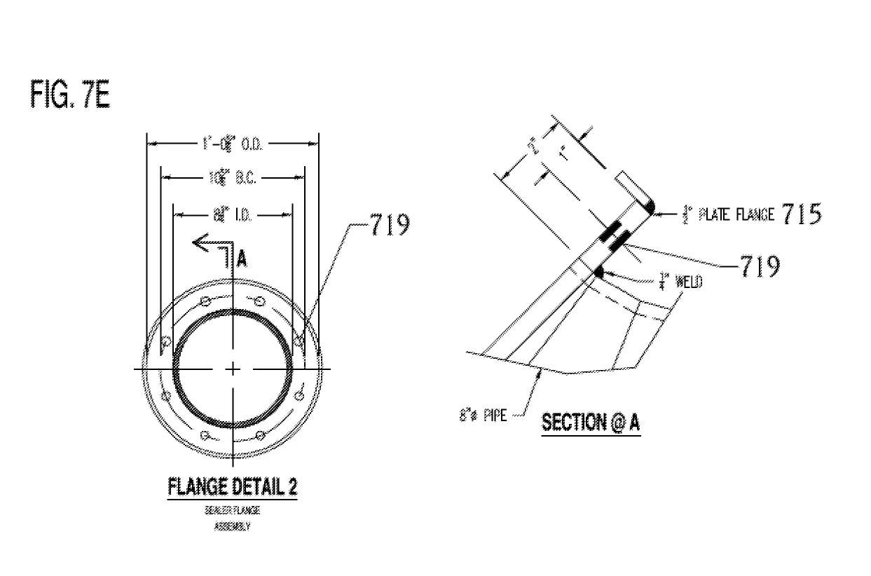

FIGS. 7A-7B are perspective views of an adjustable elbow set for a direction change of about 45 degrees, according to one embodiment. Comparing with the elbow 400 in FIG. 4A, the elbow 700 is constructed all out of round pipes, including a sealing arrangement made of flat plates and a rubber gasket. The elbow 700 is made of mild steel round pipes or tubings. The elbow 700 includes an upper section 701 and a lower section 703. FIG. 7C is cross-sectional view of the adjustable elbow, according to one embodiment. The lower section 703 is made with larger inside dimensions than the upper section 701 so that the upper section 701 can fit into the lower section 703 with sufficient tolerances for fitting. The upper section 701 is fitted into the lower section 703 in a telescopic motion along their centre lines 705 and 707, while using a cross point 709 of their centre lines as a pivot point.

FIG. 7C includes cross-sectional views of the adjustable elbow, according to one embodiment. At the mid-point along the centre line radius is a flange 711 that is made of two pieces of mild steel flat plates 713, 715 with one or more gaskets 717 (e.g., gum rubber) in-between. Tightening the bolts 719 on the smaller cross directional flange plates 713, 715 presses the gaskets 717 in-between the plates 713, 715 as well as against the body of the upper section 701.

By way of example, the upper section 701 includes a tubular section 721 and a tubular section 723. A mild steel plate is made into the tubular section 721 with inside dimensions matching the inside diameter of the tubular section 723 (e.g., of 4″-36″ diameter). The tubular section 723 can be mated to the tubular section 721 with a flat plate 725. The tubular section 721 is welded to both the flat plate 713 and the flat plate 725. The lower section 703 includes a tubular section 727, a transition/reducer 729 and a tubular section 731. The tubular section 727 is mated to the tubular section 731 by the transition 729 fabricated out of a mild steel round pipe or tubing. The transition 729 also serves to transition the flow of material through the tubular portion of the elbow 700 back into the round pipeline with a smoother and less turbulent flow to minimum wear and tear to the elbow 700 and the pipeline. Using a flat plate (rather than such a transition piece) to mate the box portion of the elbow back to the pipe portion will restrict flow and cases a high wear and tear at the joint.

FIG. 7D includes cross-sectional views of flange plates of the adjustable elbow, according to one embodiment. In addition to bolts 719, there are two side adjustment bolts 733, which are more than the one in FIG. 4D. Tightening the bolts 733 further compresses the gasket 717 against the body of the upper section 701 of the elbow to ensure sealing. FIG. 7E includes additional cross-sectional views of flange plates of the adjustable elbow, according to one embodiment. The bolts 719 and the bolts 733 in the cross directional flange points provide the embodiment a bi-directional sealing capability.

In one embodiment, the elbow 700 is lined with the various liners to match inside diameters of existing pipes. The elbow 700 can be made of plastic, copper, cast iron, steel, lead, etc. The liners can be made of a wear resistant material such as alumina oxide ceramic tile, tungsten carbide, monolithic moldings, abrasion resistant metal, silica carbide, etc.

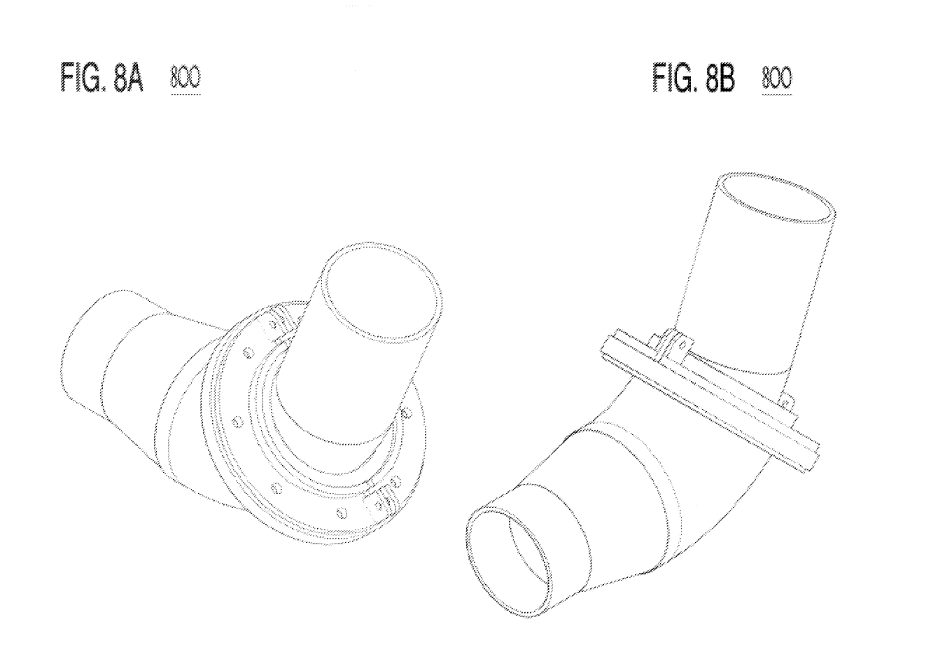

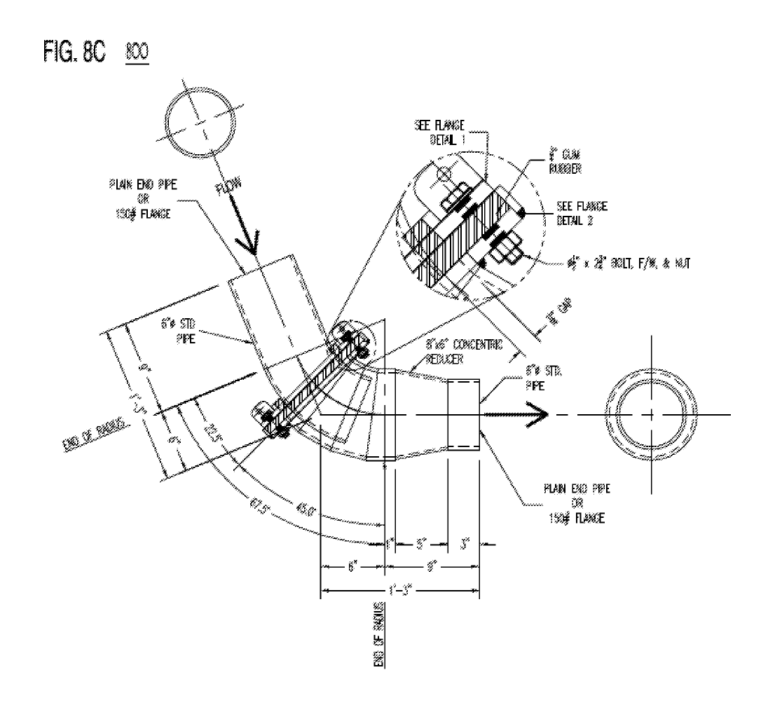

In one embodiment, the elbow 700 is installed as follows. Initially, the two sections of the elbow 700 are engaged with each other in 45 degree as shown in FIG. 7A. After taking an existing, warn-out elbow out of a pipe line, the lower section 705 of the elbow 700 is bolted or coupled to one end of the existing pipe line, then the upper section 701 is pull out of the lower section 403 until the upper section 701 is bolted or otherwise coupled to the other end of the existing pipe line. By way of example, FIGS. 8A-8B are perspective views of an adjustable elbow 800 set for a direction change of about 67.5 degrees, according to one embodiment, and FIG. 8C includes cross-sectional views of the adjustable elbow, according to one embodiment.

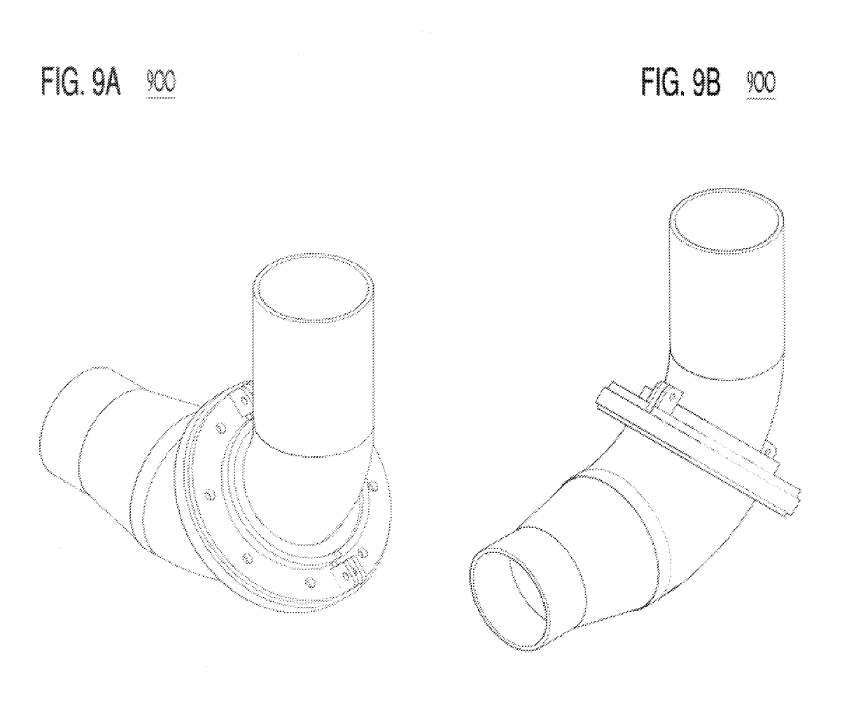

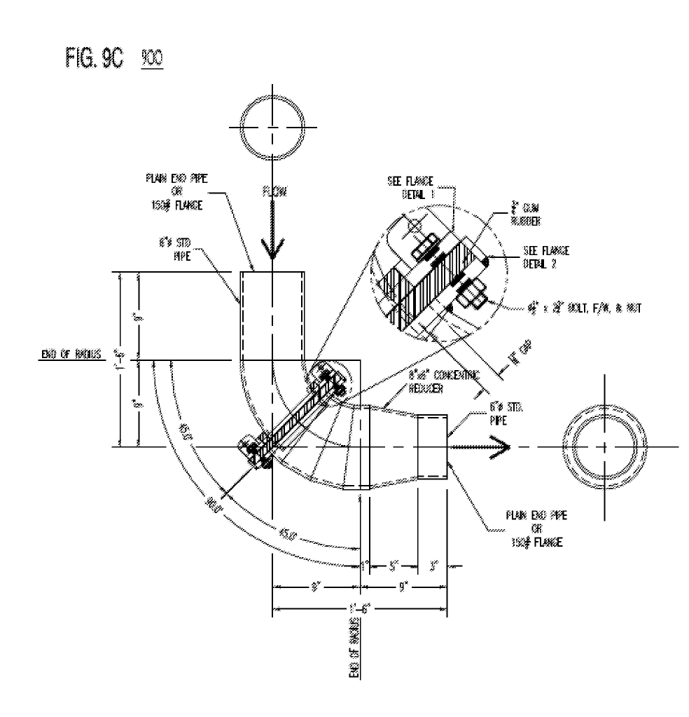

As another example, FIGS. 9A-9B are perspective views of an adjustable elbow 900 set for a direction change of about 90 degrees, according to one embodiment, and FIG. 9C includes cross-sectional views of the adjustable elbow, according to one embodiment.

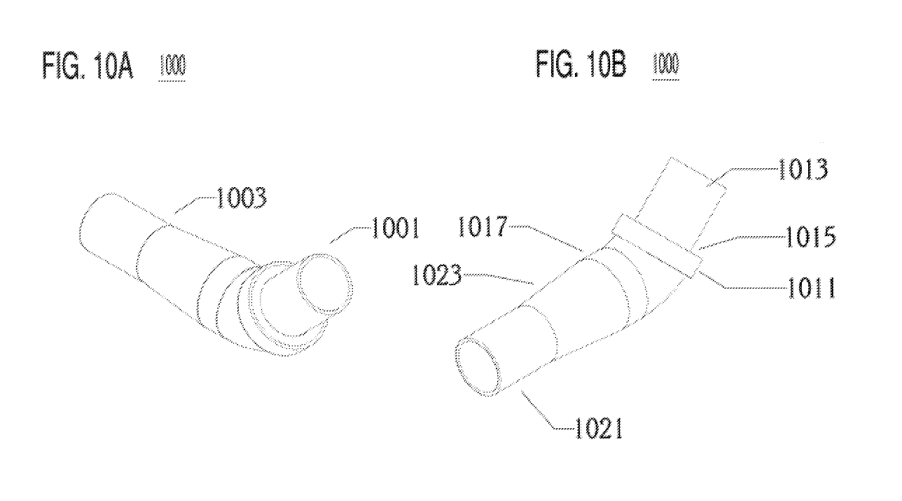

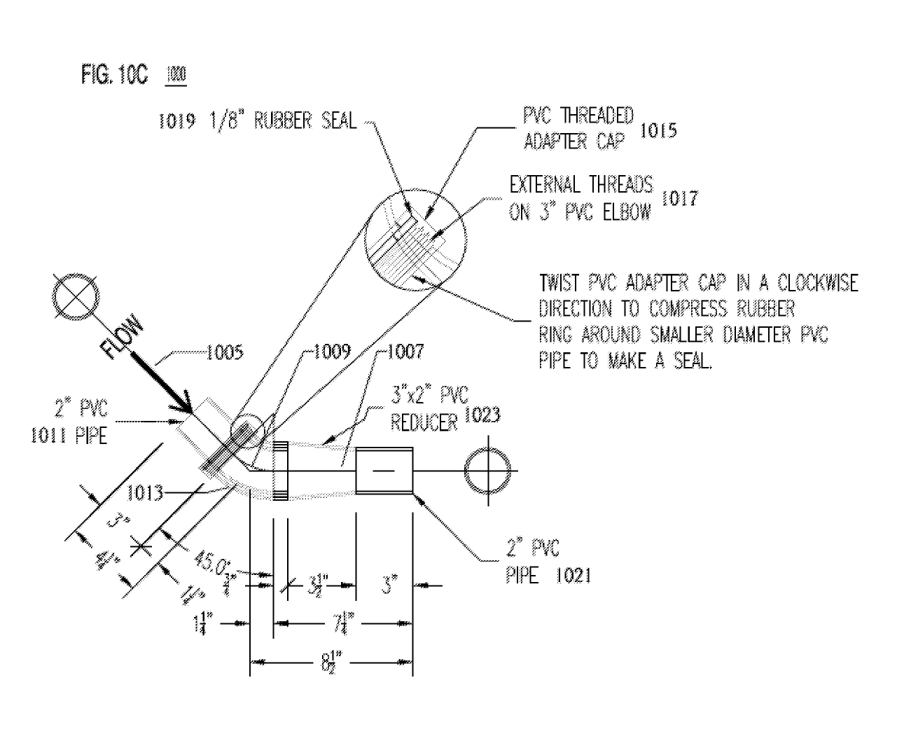

FIGS. 10A-10B are perspective views of an adjustable elbow set for a direction change of about 45 degrees, according to one embodiment. Comparing with the elbow 700 in FIG. 7A, the elbow 1000 is also constructed all out of round pipes. However, instead of flat plates and a rubber gasket, the elbow 1000 uses threads for sealing the pipes. The previously discussed elbows seal by the means of tightening bolts in flat plate flanges to compress the rubber gasket to seal around the body of the upper section, the elbow 1000, in one embodiment, threads inner threads of a larger diameter tubular section with external threads of a smaller diameter tubular section.

In another embodiment, the elbow 1000 is installed as follows. Initially, the tubular sections of the elbow 1000 are engaged with each other in 45 degree as shown in FIG. 10A by placing the small diameter pipe inside the large diameter pipe. An adapter cap with internal threads is used to join the tubular sections together by turning the adapter cap in a clockwise direction. The adapter cap not only joins the tubular sections together but also compresses a rubber gasket against the upper tubular section to seal it off.

The elbow 1000 is made of PVC plastic pipes, plastic molded pipes, or a combination thereof. The elbow 1000 includes an upper section 1001 and a lower section 1003. FIG. 10C is cross-sectional view of the adjustable elbow, according to one embodiment. The lower section 1003 is made with larger inside dimensions than the upper section 1001 so that the upper section 1001 can fit into the lower section 1003 with sufficient tolerances for fitting. The upper section 1001 is fitted into the lower section 1003 in a telescopic motion along their centre lines 1005 and 1007, while using a cross point 1009 of their centre lines as a pivot point.

By way of example, the upper section 1001 includes a tubular section 1011 and a tubular section 1013. The PVC tubular section 1011 has a diameter matching the inside diameter of the PVC tubular section 1013 (e.g., of 2″-36″ diameter). The tubular section 1013 can be coupled to the tubular section 1011 with an adaptor cap 1015 threaded to the external thread 1017 of the tubular section 1013. A tubular section 1017 of the lower section 1003 is connected with a tubular section 1021 via a (e.g., 3″-to-2″) transition/reducer 1023. The transition/reducer 1023 serves to transition the flow of material through the tubular section 1017 of the elbow 1000 back into the tubular section 1021 with a smoother and less turbulent flow to minimum wear and tear to the elbow 1000 and the 2″ pipeline.

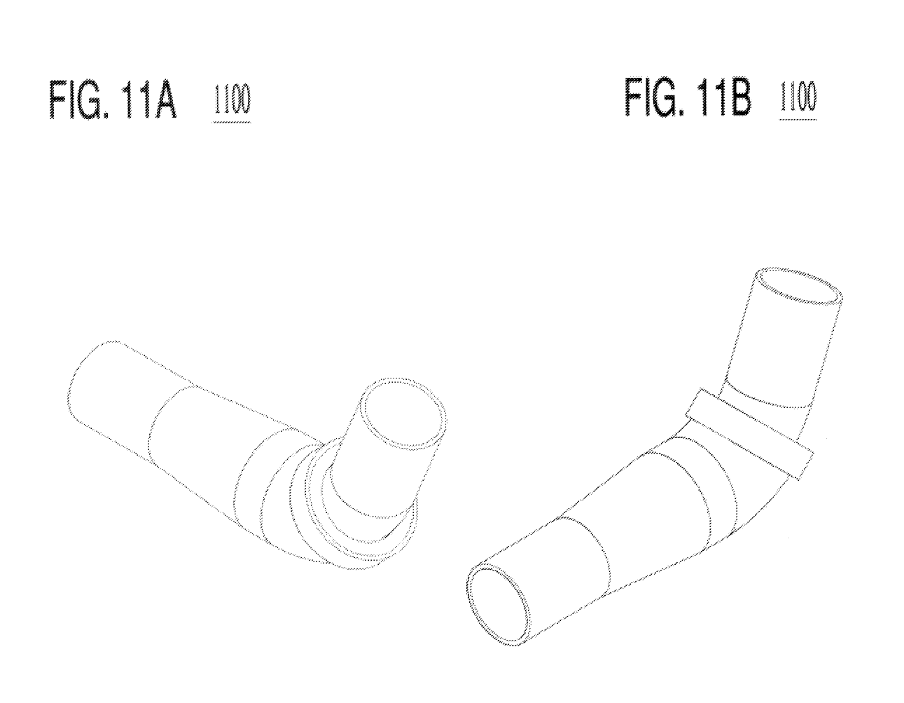

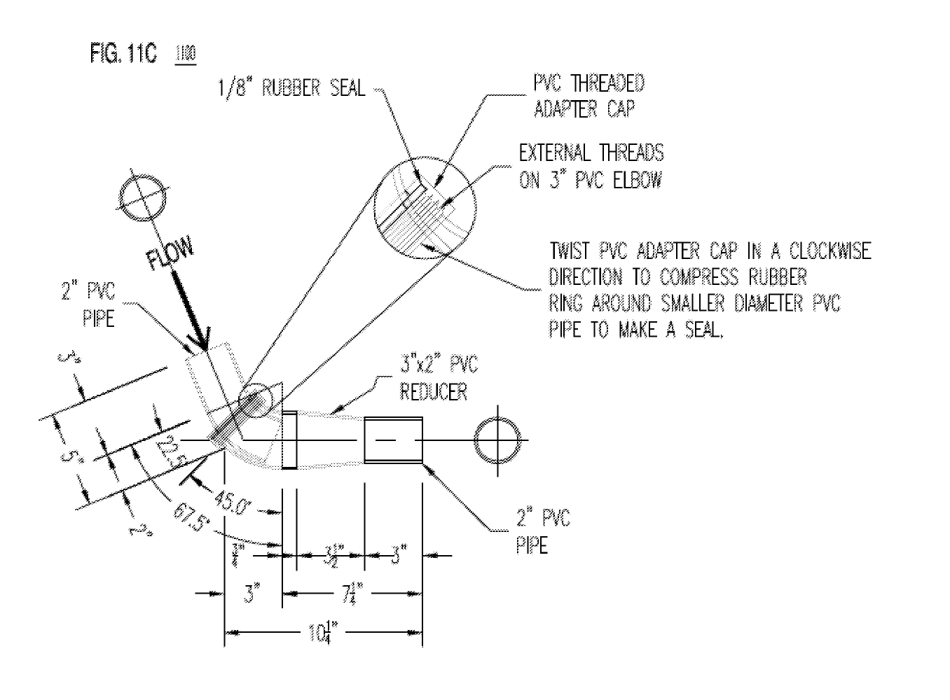

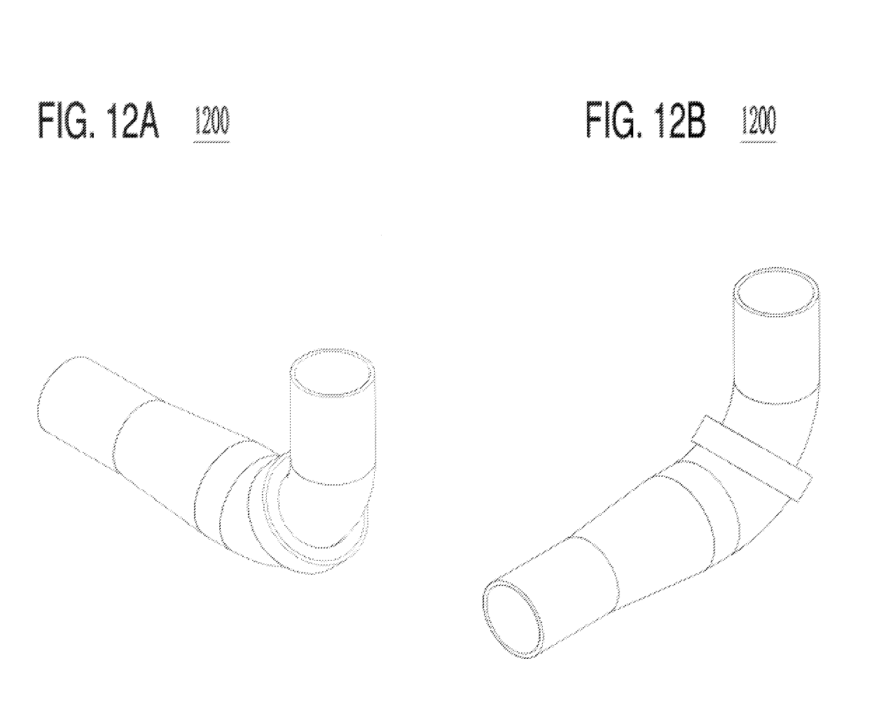

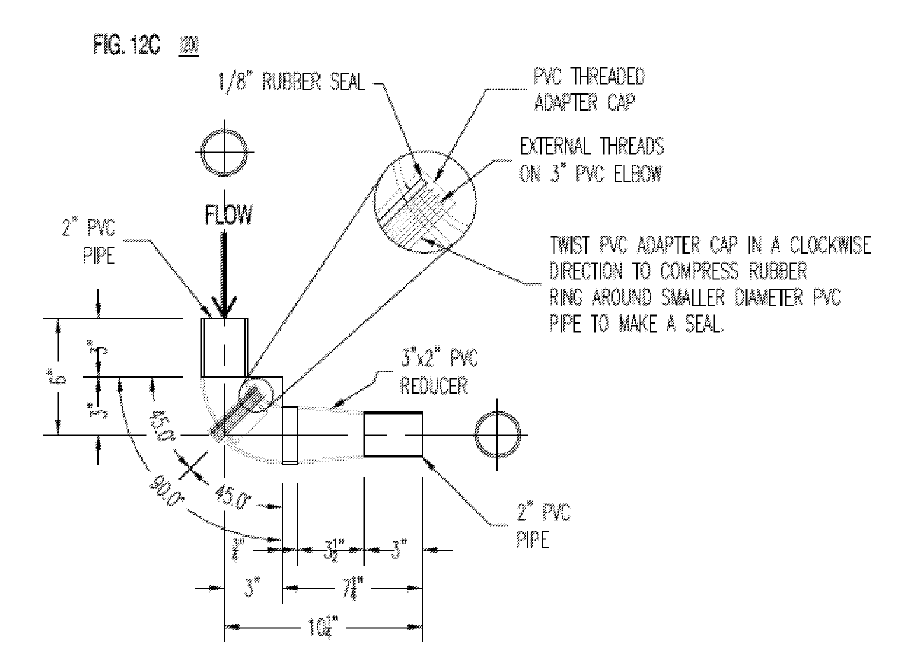

FIGS. 11A-11B are perspective views of an adjustable elbow 1100 set for a direction change of about 67.5 degrees, according to one embodiment; and FIG. 11C includes cross-sectional views of the adjustable elbow, according to one embodiment. As another example, FIGS. 12A-12B are perspective views of an adjustable elbow 1200 set for a direction change of about 90 degrees, according to one embodiment, and FIG. 12C includes cross-sectional views of the adjustable elbow, according to one embodiment.

In one embodiment, the upper section (e.g., 101) of the elbow (e.g., 100) is connected to a feed end of the pipeline, while the lower section (e.g., 103) is connected to a discharge end of the pipeline. In another embodiment, at least one of the upper section and the lower section has a square-to-round transition/reducer to adjust the flow speed and/or to create a turbine of the liquid/material transferred there through.

In one embodiment, the upper section is connected to a discharge end of the pipeline, while the lower section is connected to a feed end of the pipeline. In another embodiment, at least one of the upper section and the lower section has a square to round transition to adjust the flow speed and/or to create a turbine of the liquid/material transferred there through.

The elbows can be used in industries deploying pipe lines to transporting fluid (e.g., water), gas, waste, etc. in ordinary domestic or commercial environments, such as coal processing industrial pipeline networks, power generation industrial pipeline networks, pulp and paper industrial pipeline networks, powder and bulk industrial pipeline networks, public service authorities pipeline networks, water treatment plants, water supply facilities, food industrial pipeline networks, chemical industrial pipeline networks, electronic industrial pipeline networks, air conditioning facility pipeline, agriculture and garden production transporting system, pipeline network for solar energy facility, etc. The piping may support high-performance, e.g., high pressure, high flow, high temperature, hazardous materials in specialized applications.

In certain embodiments, the above-described pipe system can be telescopically engaged an upper section with a lower section along a central line to provide a desired degree of elbow along a central pivot point.

Also, the system can be adapted to different styles and designs for various industrial, commercial, and/or residential demands, while avoiding hiring an engineering firm or fabrication company to measure and fit an elbow, or measuring or cutting a steel cast elbow.

Each new model of adjustable elbows (with various pipe diameters, flange thicknesses, gasket types, etc.) can be pressure tested (e.g., 150% of the target field pressure) for planned field conditions prior to field installation. The flanges and bolted/welded connections can be designed and customized for the planned pressure applications, considering the variability in pipe sizes, elbow angles, pressure conditions, corrosion potentials, types of pipe lining, etc.

By way of example, the adjustable elbow can be customized for the pipe industry as well as the lined pipe industry. Therefore, multiple variations of pipe sizes (e.g., box, tubular, etc.) and flanges are provided. Air pressure testing can be conducted to adapt and/or ensure that the adjustable elbow functions in pressurized piping application, such as gravity flow systems, pressurized piping applications, etc.

Before deploying the adjustable elbow, testing can be performed by placing blank flanges on each end of the elbow. One of the blank flanges can be fitted to an air compressor line to allow the elbow to be filled with compressed air. The elbow may be separated at a transverse central line (i.e., an adjustment point) at certain air pressure load (e.g., 40 psi) due to inadequate end restraint for the elbow. Adequate end restraint is used to prevent movement at the transverse central line.

By way of example, initial testing was performed on the elbow 400 using a rubber gasket with a hardness of 80 durometers, which determined that the gasket material of softer rubber seals better. As another example, the ends of the elbow 700 were restrained using chains to prevent the elbow from separating at the adjustment point. The chain restraints serve to simulate the restraint provided by attaching the elbow ends to adjacent restrained tubular sections. The elbow 700 was then tested using a rubber gasket with a hardness of 40 durometers rubber gasket material. Air pressure testing started with a test pressure of 40 psi; at a test pressure of approximately 50 psi, minor movements occurred in the elbow 700 as the chain restraints were placed in tension. This movement stopped once the chain restraints were mobilized. The pressure was then increased to 80 psi to determine if bleed-off will occur. Bleeding did not occur for a period of approximately two hours under 80 psi. In a separate test, the pressure was increased to 90 psi for 90 minutes, and breeding did not occur.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An adjustable elbow comprising:
a first section; and
a second section telescopically fitted into the first section to adjust an angle of the elbow.

2. An adjustable elbow of claim 1, further comprising:
one or more sealing arrangements configured to seal one end of the second section fitted into one end of the first section at the angle, wherein the one or more sealing arrangements include one or more gaskets.

3. An adjustable elbow of claim 2, wherein the one or more sealing arrangements further include one or more bolts, one or more flanges, one or more threads on at least one of the ends of the first and second section, one or more adapting caps, or a combination thereof.

4. An adjustable elbow of claim 3, wherein the one or more bolts secure the one or more flanges to each other along a flow direction, perpendicular to the flow direction, or a combination thereof.

5. An adjustable elbow of claim 3, wherein the one or more threads include at least one external thread of the first section configured to be engaged with at least one internal thread of the second section.

6. An adjustable elbow of claim 3, wherein the one or more threads include at least one external thread of the first or second section configured to be engaged with at least one internal thread of the second section of at least one of the adapting caps.

7. An adjustable elbow of claim 1, further comprising:
a transition section to couple the first or second section to a downstream section of a different shape, size, material, or a combination thereof

8. An adjustable elbow of claim 1, wherein the angle is set in a range of about 22.5-90 degrees.

9. An adjustable elbow of claim 1, wherein the angle is set in a range of about 45-90 degrees.

10. A method comprising:
providing an adjustable elbow including a first section and a second section; and
telescopically fitting the second section into the first section to adjust an angle of the elbow.

11. A method of claim 10, further comprising:
providing one or more sealing arrangements include one or more gaskets; and
sealing one end of the second section fitted into one end of the first section at the angle and with the one or more gaskets in-between.

12. A method of claim 11, wherein the one or more sealing arrangements further include one or more bolts, one or more flanges, one or more threads on at least one of the ends of the first and second section, one or more adapting caps, or a combination thereof.

13. A method of claim 12, further comprising:
securing the one or more flanges to each other with the one or more bolts along a flow direction, perpendicular to the flow direction, or a combination thereof.

14. A method of claim 12, further comprising:
engaging at least one external thread of the first section with at least one internal thread of the second section to seal elbow at the ends.

15. A method of claim 12, further comprising:
engaging at least one external thread of the first or second section with at least one internal thread of the second section of at least one of the adapting caps to seal elbow at the ends.

16. A method of claim 12, further comprising:
regulating a flow current by coupling the first or second section to a downstream section with a transition section, wherein the downstream section has a shape, size, material, or a combination thereof different from a shape, size, material, or a combination thereof, of the first or second section.

17. A method comprising:
providing an adjustable elbow including a first section, a second section, and one or more sealing arrangements include one or more gaskets;
telescopically fitting the second section into the first section to adjust an angle of the elbow;
sealing one end of the second section fitted into one end of the first section at the angle with the one or more gaskets in-between; and
pressure-testing the elbow sealed at the angle, prior to deploying the sealed elbow on-site.

18. A method of claim 17, further comprising:
varying one or more pressure conditions, one or more corrosion potentials, one or more types of linings of the first or second section, one or more flange thicknesses, one or more gasket types, or a combination thereof, based upon one or more site conditions.

19. A method of claim 17, further comprising:
covering the sealed elbow with blank flanges; and
fitting compressed air into the covered allow to a set pressure level for a predetermined period of time.

20. A method of claim 19, further comprising:
applying end restraints on the blank flanges to prevent movement at a transverse central line of the covered elbow.
